(19) United States
(12) Patent Application Publication
(10) Pub. No.: US 2022/0212397 A1
(43) Pub. Date: Jul. 7, 2022

(54) METHOD FOR REPAIRING A PART DURING ADDITIVE MANUFACTURING

(71) Applicant: INSTITUT DE RECHERCHE TECHNOLOGIQUE JULES VERNE, Bouguenais (FR)

(72) Inventor: Francois Edy, Reze (FR)

(21) Appl. No.: 17/610,837

(22) PCT Filed: May 19, 2020
(86) PCT No.: PCT/EP2020/063993

§ 371 Date: Nov. 12, 2021

(30) Foreign Application Priority Data
May 23, 2019 (FR) FR1905452

(51) Int. Cl. B29C 64/118; B29C 64/209; B29C 64/232; B29C 64/236; B29C 64/245; B29C 64/336; B29C 64/393; B33Y 10/00; B33Y 30/00; B33Y 50/02

(52) U.S. Cl. CPC B29C 64/118; B29C 64/209; B29C 64/232; B29C 64/236; B33Y 50/02; B29C 64/336; B29C 64/393; B33Y 10/00; B33Y 30/00; B29C 64/245

(57) ABSTRACT

A method for repairing a part during layer-by-layer additive manufacturing using an additive manufacturing machine. The additive manufacturing being material extrusion printing, and the method including the following steps a) depositing at least one layer of material on a support (2) for manufacturing the part (P), b) detecting at least one missing material defect, if one or more defects of this type are present on said at least one layer, c) repairing said at least one missing material defect by adding material, and d) repeating steps a), b) and optionally c) until the part (P) is produced.

The present invention relates to a method for repairing a part during layer-by-layer additive manufacturing.

### TECHNICAL FIELD

In the field of additive manufacturing, in particular but not solely fused filament extrusion or fused deposition modeling (FDM), parts produced layer by layer can have defects generated during the process, for example.

Additive manufacturing methods are generally time-consuming and the part produced can be found to be defective during final inspection and therefore scrapped. The material used is then wasted, when it is generally costly. In addition, the process time taken to produce the part is wasted. It can thus be advantageous to inspect the part as it is being manufactured.

US 2019/0009472 discloses a method for inspecting a 3D printed part with a 3D printer.

US 2016/129633 relates to a device and method for 3D printing by stacking a plurality of layers. A printing module sprays liquid material onto a stage. A curing module cures the liquid material on the stage to form a layer. A sensing module is configured to detect the surface profile of the layer formed. A control module receives the profile signal and controls the printing module and the curing module as a function of the detected profile to correct the surface of the layer formed.

There is a need to improve the existing additive manufacturing methods.

### DISCLOSURE OF THE INVENTION

The present invention thus relates, according to a first aspect thereof, to a method for repairing a part during layer-by-layer additive manufacturing using an additive manufacturing machine, including the following steps:
a) depositing at least one layer of material on a support for manufacturing the part,
b) detecting at least one missing material defect, if one or more defects of this type are present on said at least one layer,
c) repairing said at least one missing material defect by adding material,
d) repeating steps a), b) and optionally c) until the part is produced.

The invention provides an additive manufacturing method that makes it possible to repair, during additive manufacturing, any missing material defects detected. The missing material defects of the part can be monitored and the missing material defect(s) can be repaired by adding material, during the manufacturing of the part, in the appropriate location.

Preferably, a single layer of material is deposited in step a) and step b) is implemented for this layer after deposition. Missing material defects can thus be monitored as the part is constructed, layer by layer.

As a variant, several layers of material are deposited in step a) before step b) is implemented.

In another variant, steps a) and b) are interlinked, with detection being performed as the material is deposited to form a layer.

Likewise, the repair step c) can be performed after the production of each layer. As a variant, it is performed after the production of several layers.

Step a) of depositing said at least one layer of material is for example performed using a nozzle fastened to a carriage, in particular of the additive manufacturing machine, said carriage being movable along at least two axes, preferably three orthogonal axes, relative to the support.

The material added in step c) can be different from the material deposited for each layer in step a), preferably being more fluid. It is preferably compatible. It can be of the same type. As a variant, the material added in the repair step c) is identical to the material deposited for each layer in step a).

Step c) of repairing said at least one missing material defect can be carried out by the nozzle. As a variant, step c) of repairing said at least one missing material defect is carried out by a second nozzle. Such a second nozzle is preferably present on the additive manufacturing machine, preferably near the nozzle, which then becomes the main nozzle.

In this case, the second nozzle preferably has a smaller diameter than the main nozzle, in particular for filling zones with smaller dimensions corresponding to the missing material defects.

Repairing one or more missing material defects can consist of depositing material in the zone(s) in which said defect(s) has/have been detected, in a quantity that is determined in order to fill said defect(s). In this case, in addition to detecting said defect(s) and the optional acquisition of related topographical data, the method can include a step consisting of calculating the quantity of material to be deposited in each identified given zone with a missing material defect.

Repairing the missing material defects by adding material, in particular using the second nozzle, can be particularly advantageous for large parts. In order to manufacture large parts, the width and height dimensions of the deposit are generally increased. Increasing the width can result in the path not correctly filling all of the zones. Adding material in the zones where material is missing, in particular by using a second nozzle, makes it possible to fill these unwanted holes.

Step b) of detecting at least one missing material defect can include a step consisting of scanning said at least one layer, deposited in step a), in order to acquire topographical data about said at least one layer, and a step consisting of processing the data acquired in order to detect and geolocate at least one missing material defect, if one or more defects of this type are present on said at least one layer.

In this case, the scanning step can be implemented using a scanning tool selected from the group consisting of a profilometer, in particular a laser profilometer, a distance sensor, a camera, a mechanical profilometer or a 3D scanner, preferably a structured light scanner, capable of scanning the part.

The additive manufacturing machine advantageously includes an enclosure, in particular closed and optionally heated, the support for the part being present in the enclosure. The nozzle advantageously emerges into the enclosure. If present, the second nozzle also advantageously emerges into the enclosure.

In this case, and if the additive manufacturing machine includes an enclosure, the scanning tool, in particular the profilometer, is preferably positioned outside the enclosure and the scanning step b) can be implemented by the profilometer through a wall portion transparent to the wavelength of the profilometer, in the visible range, between 380 nm and 800 nm. The transparent wall portion preferably forms at least part of a wall defining the enclosure. The transparent wall portion can form a glazed wall.

The scanning tool is preferably non-intrusive, being outside the part.

The scanning tool, in particular the profilometer, is preferably stationary relative to the carriage, being in particular fastened near the nozzle. The carriage can form part of a wall defining the enclosure and/or be mounted on such a wall.

The carriage to which the nozzle and the scanning tool, in particular the profilometer, are rigidly connected, can be movable or stationary. In the latter case, the support for manufacturing the part is advantageously movable along at least two axes (X, Y), or even three orthogonal axes (X, Y, Z). This relative mobility of the carriage and/or the support makes it possible to deposit the material in the location specified for the construction of each layer of the part.

The additive manufacturing method, also known as synthesis additive manufacturing, can be a material extrusion printing method, which includes in particular fused deposition modeling (FDM) or fused filament fabrication (FFF), binder jetting 3D printing, which includes in particular drop-on-demand (DOD) technology, powder bed fusion 3D printing, which includes in particular selective laser sintering (SLS) and selective laser melting (SLM) technologies, material jetting 3D printing, directed energy deposition 3D printing, or vat photopolymerization 3D printing, which includes in particular stereolithography (SLA) technology. The method can also be a mixture of these different technologies such as multi jet fusion (MJF) technology, which combines binder jetting and power bed fusion. The additive manufacturing method for the part is preferably FDM or FFF.

The material used for additive manufacturing and/or the material added in the repair step c) is preferably a polymer, in particular a thermoplastic polymer selected for example from the group consisting of PAEKs (polyaryletherketone), including PEEK (polyetheretherketone) and PEKK (polyetherketoneketone), PEIs (polyetherimide, also known as ULTEM), PPS (polyphenylene sulfide), ABS (acrylonitrile butadiene styrene), PA (polyamide), PP (polypropylene), PLA (polylactic acid), TPU (thermoplastic polyurethane) and PET (polyethylene).

The polymer can be amorphous and/or semi-crystalline, filled or unfilled.

The polymer can be filled with fibers, in particular carbon/glass fibers, mineral, metal or plant filler, in particular glass or wood spheres, or be unfilled.

Pairs of materials that can be used can be established, in particular compatible with each other, one of the materials being able to be deposited in step a) and the other material being able to be deposited in step c) of repairing one or more missing material defects.

Thus, in the case of materials in the PEKK family, in one example, the nozzle extrudes and deposits a PEKK 6003 polymer filament, while, for the repair in step c), the second nozzle extrudes and deposits a more fluid PEKK 6004 polymer. In another example, the nozzle extrudes and deposits a PEKK 6004 CF carbon fiber-filled polymer filament, while, for the repair in step c), the second nozzle extrudes and deposits a PEKK 6004 unfilled polymer. As a variant, the same material, for example PEKK 6004 CF, can be deposited by both of the nozzles or by the nozzle.

Step a) is preferably carried out by depositing extruded polymer filament. Step c) is preferably carried out by depositing extruded polymer filament.

The method can include a step prior to the first implementation of step a), consisting of scanning the support for receiving the part during manufacturing, before deposition of the first layer of the part. This provides a reference for the subsequent manufacturing of the part.

Step b) of detecting at least one missing material defect can make it possible, in particular by scanning, to acquire data that can comprise the three-dimensional coordinates of the layer deposited and scanned.

The processing of data acquired, in particular by scanning, can include, on the basis of the data acquired, the analysis of at least one overall value in order to monitor the additive manufacturing, layer by layer. The overall value is preferably selected from a thickness of the deposited layer, a standard deviation of the thickness of the deposited layer, a quantity of material deposited for the layer, a movement of the carriage on each layer deposited, the mean width of the beads of deposited filament and the standard deviation thereof when the additive manufacturing is carried out by deposition of extruded polymer filament, the mean roughness, in particular with the parameter Ra (arithmetic mean height of a line) or Sa (arithmetic mean height of a surface) and the geometric dimensions of the deposited layer.

The data acquired, in particular by scanning, can make it possible to identify zones of missing material, inspect the geometry of the material deposition on each layer, inspect a roughness between layers, and find out the void rate within a layer, several layers or the part.

The method can include a prior step of configuring the additive manufacturing machine to perform step a) with setpoint parameters and on the basis of reference geometric data for the part and/or for each layer of the part, stored in a memory.

In this case, the processing of the data acquired, in particular by scanning, advantageously includes a comparison of the data acquired in with the setpoint parameters and a detection of any deviation between the data acquired and the setpoint parameters.

Still in this case, the data processing can include a comparison of the data acquired, in particular by scanning, with the stored reference geometric data, in order to detect a mean deviation of the outline of the part relative to the reference geometric data, and/or a mean deviation relative to the paths of deposition of the material forming the part.

The data acquired can make it possible to recognize the outlines of the layer, layers or manufactured part and thus reconstruct the part actually manufactured, layer by layer, and compare it with the initial reference data. This can make it possible to perform quality control and accept or reject the part from a dimensional point of view or allow the implementation of the repair step c).

The paths of deposition of the material forming the part can correspond, when the additive manufacturing is extruded polymer filament deposition, to the paths of the nozzle, which is for example controlled by numerical control programming.

The processing of the data acquired, in particular by scanning, can include determining the surface dimension and the depth of each missing material defect. When the surface dimension and the depth of a missing material defect are respectively greater than predetermined surface dimension and depth threshold values, the data about this defect can be recorded, said data including in particular the coordinates, surface dimension and depth of the defect.

The predetermined surface dimension threshold value is for example 5 μm*5 μm, or even greater than 5 μm*5 μm, for example 50 μm*50 μm. The predetermined depth threshold value can be 10 μm, or even greater than 10 μm, for example 100 μm.

If it is determined, by data processing, that repair is undesirable or impossible, for example due to the presence of a number of defects greater than a predetermined threshold value and/or due to the presence of at least one defect with dimensions greater than a predetermined threshold, the method can include the scrapping of the part, even unfinished, the threshold values being predetermined for a given part.

This makes it possible to save process time and material that would otherwise be used to finish the part. The implementation of the method is relatively time-consuming, and can take several hours, and the material used, in particular polymer material, is relatively expensive. The saving made, when a part has a major defect or a set of defects that render it non-compliant with the required level of quality, can thus be substantial if it can be scrapped as soon as its non-compliance is determined, during manufacturing.

After a repair has been made, the method can include a step consisting of scanning the repaired layer. This makes it possible to check that the missing material defect(s) have been repaired satisfactorily. If this is not the case, another repair step c) can be performed as a function of the data acquired and analyzed. If the repair is deemed satisfactory, another layer can be deposited in another step a).

### Additive Manufacturing Machine

According to another of its aspects, in combination with the above, the invention also relates to an additive manufacturing machine for implementing the method as defined above, the additive manufacturing preferably being material extrusion printing (FDM, FFF), the machine including:
a support for the part to be manufactured,
at least one spool of polymer material filament,
at least one nozzle for extruding and depositing the filament in order to form the part,
a carriage to which the nozzle and optionally a second nozzle is/are fastened,
at least one of the carriage and the support being movable along at least two axes, in particular three axes, relative to the other, said at least one nozzle being used for repairing missing material defects or the machine including a second nozzle for repairing missing material defects, the second nozzle preferably having a smaller diameter than the nozzle.

The additive manufacturing machine preferably includes a scanning tool selected from the group consisting of a profilometer, in particular an optical, camera or laser profilometer, preferably a laser profilometer, a distance sensor, a camera, a mechanical profilometer and a 3D scanner, preferably a structured light scanner, preferably a profilometer, capable of scanning the part.

The additive manufacturing machine can include an enclosure, in particular closed. In this case, the support can be in the enclosure, and the scanning tool, in particular the profilometer, is preferably outside the enclosure, the nozzle, and optionally the second nozzle, emerging into the enclosure. The carriage can form all or part of a wall of the enclosure and/or be rigidly connected to such a wall.

The enclosure can be heated or not and its heating temperature, if applicable, can vary, depending on the materials used for additive manufacturing. For some materials, it is preferable that it be heated. However, some materials do not require a heated enclosure.

The heating temperature of the enclosure is for example defined as a function of the T_{g} (glass transition temperature) of the material used for additive manufacturing. For example, for ABS, the enclosure can be heated to a temperature of between 50° C. and 100° C. For PEKK, the temperature of the enclosure will be approximately 150° C.

The heating temperature of the enclosure can be up to 250° C.

The enclosure can in particular be heated to avoid the deformations generated by excessive temperature gradients in the part during the manufacturing thereof.

The additive manufacturing machine can further include a wall, for example forming part of a wall of the enclosure, transparent to the wavelength of the profilometer, positioned so as to allow the profilometer to scan at least one portion of the part through this wall.

### BRIEF DESCRIPTION OF THE DRAWINGS

The invention will be better understood from reading the following detailed description of non-limiting exemplary embodiments thereof, and from examining the appended drawing, in which:

FIG. 1 schematically shows an example of an additive manufacturing machine according to the invention,

FIG. 2 is a block diagram showing the steps of a particular embodiment of the additive manufacturing method,

FIG. 3 schematically shows an example of a part produced using the additive manufacturing method described with reference to FIG. 2,

FIG. 4 is a graph of data originating from the scanning step in the embodiment of the method for several parts according to FIG. 3,

FIG. 5 is a graph of data originating from the scanning step in the embodiment of the method for several parts according to FIG. 3,

FIG. 6 is a graph of data originating from the scanning step in the embodiment of the method for several parts according to FIG. 3,

FIG. 7 is a graph of data originating from the scanning step in the embodiment of the method for several parts according to FIG. 3,

FIG. 8 includes several schematic images resulting from the processing of data originating from the scanning step, for different layers of the part in FIG. 3, during the implementation of the method according to the invention,

FIG. 9 is an enlarged photograph illustrating a portion of the part in FIG. 3,

FIG. 10 is a block diagram showing the steps of an embodiment of the method for repairing a part during additive manufacturing according to the invention,

FIG. 11 schematically shows an example of an additive manufacturing machine according to the invention for implementing the method illustrated in FIG. 10, and

FIG. 12 schematically shows the result of the scan of an example of a part to be repaired using the method according to the invention.

### DETAILED DESCRIPTION

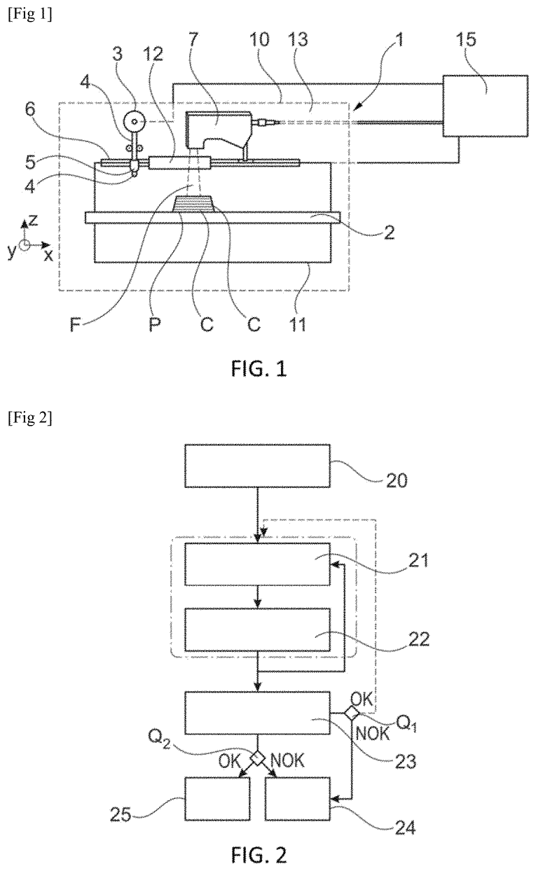

FIG. 1 illustrates an additive manufacturing machine 1 for producing a part P layer by layer and allowing the repair of any missing material defects. In the example illustrated, the additive manufacturing technique is a fused filament deposition printing method, which technology is known as FDM, or FFF.

The machine 1 includes a cabinet 10 shown in dashed lines in this figure. The machine 1 includes, housed in the cabinet 10, a support 2 for the part P to be manufactured, at least one spool 3 of polymer material filament 4, a nozzle 5 for extruding and depositing the filament 4 in order to form the part P, and a carriage 6 to which the nozzle 5 is fastened.

At least one of the carriage 6 and the support 2 is movable along at least two axes X, Y, in in this example along three axes X, Y and Z, relative to the other. In the example illustrated, the carriage 6 is movable relative to the support 2, but the support 2 can be movable and the carriage 6 can be stationary, or both the carriage 6 and the support 2 can be movable relative to each other, without departing from the scope of the invention.

The machine 1 further includes a scanning tool, consisting in this example of a profilometer 7, in this example a laser profilometer, in particular class 2, stationary relative to the carriage 6. The profilometer 7 makes it possible to scan the part P and acquire topographical data about the part P, layer by layer for example. The profilometer chosen in this example has an observation zone 39 mm wide, for obtaining a resolution of 0.05 mm. The measuring head of the profilometer can be changed in order to increase the width scanned, which leads to a reduction in resolution, or to reduce it, in order to increase the resolution. Several passes are performed in order to scan a part with dimensions larger than the width measured.

The machine 1 comprises, in the cabinet 10, a closed enclosure 11. In this example, the enclosure 11 is heated, to a temperature of approximately 150° C., for a material used for the additive manufacturing consisting of PEKK. The enclosure 11 contains the support 2, which holds the part P, here shown with several layers C deposited. The profilometer 7 is situated outside the enclosure 11, in a temperature-controlled space 13 of the machine 1. The machine 1 includes a wall portion 12 transparent to the wavelength of the profilometer 7, positioned so that the profilometer 7 can scan at least a portion of the part P through this wall portion 12. The wall portion 12 can be rigidly connected to the carriage 6 to which the nozzle 5 and the profilometer 7 are fastened. The nozzle 5 emerges into the enclosure 11 for depositing material in order to manufacture the part layer by layer.

The machine 1 further includes a computer system 15 connected at least to the profilometer 7 in order to collect data from it, to the spool 3 to control the deposition of material, and to the carriage 6 so as to control the movement thereof on the X, Y and Z axes. As a variant, the computer system 15 connected to the profilometer 7 is different from the one controlling the machine 1, but these two computer systems can communicate with each other when necessary, for example in the event of a machine shutdown.

The additive manufacturing machine 1 can be used to implement the additive manufacturing method, which will be described with reference to FIG. 2, which illustrates the steps thereof.

The additive manufacturing method for the part P includes a first step 20 including the scanning of the support 2, using the profilometer 7, before the first layer C of the part P is deposited. This measurement is performed in order to obtain a reference distance between the profilometer and the support, and is a calibration step. This acquisition of data relating to the support 2 can be omitted in a variant embodiment of the invention.

A first layer of the part P is then produced, by depositing an extruded polymer material filament using the nozzle 5, in a step 21. The carriage 6 is moved relative to the support 2 in order to deposit material in the desired location.

In a step 22, the first layer C of the part P, deposited in step 21, is scanned using the profilometer 7, through the transparent wall 12. The beam F can be seen in FIG. 1. The carriage 6 can be moved relative to the support 2 to carry out the scan.

In a step 23, the data acquired is processed in order to detect and geolocate at least one missing material defect, if one or more defects of this type are present, in particular on the first layer C deposited in step 21.

As illustrated, steps 21 and 22 can be carried out several times before step 23 is implemented. In addition or as a variant, as illustrated, steps 21 and 22 can be repeated after the implementation of step 23 until all of the layers of the part P have been produced.

In one variant, step 21 consists of depositing not one, but several, layers C before performing the scanning step 22. In another variant, the scan in step 22 is performed as soon as the material is deposited, before the whole layer C has been produced, as it is being deposited.

The scan performed in step 22 makes it possible to acquire topographical data about the layer C deposited. For example, the X, Y and Z coordinates of the top layer C of the part being manufactured, the layer which has just been deposited, can be obtained.

The data processing step 23 includes in particular, on the basis of the data acquired, the analysis of at least one or more overall values in order to monitor the additive manufacturing method, layer by layer. The overall values analyzed can include a thickness of the deposited layer C, a standard deviation of the thickness of the deposited layer C, a quantity of material deposited for the layer C and a movement of the carriage 6 and/or of the support on each layer C deposited, a mean roughness, and a mean width of the beads of deposited filament.

During step 20, in the example illustrated, the additive manufacturing machine 1 is also configured to carry out step 21 with setpoint parameters and on the basis of reference geometric data for the part P and/or for each layer C of the part P, stored in a memory of the computer system 15.

The processing step 23 includes a comparison of the data acquired in step 22 with the setpoint parameters and a detection of any deviation between the data acquired and the setpoint parameters.

The processing step 23 further includes a comparison of the data acquired in step 22 with the stored reference geometric data, in order to detect a mean deviation of the outline of the part P relative to the reference geometric data and/or a mean deviation relative to the paths of deposition of the material forming the part P, programmed before manufacturing. Step 23 also includes the determining of the surface dimension and the depth of each missing material defect and, when the surface dimension and the depth of a missing material defect are respectively greater than predetermined surface dimension and depth threshold values, the recording of the data about this defect, said data including in particular the coordinates, surface dimension and depth of the defect.

In the example illustrated, the predetermined surface dimension threshold value is 50 μm*50 μm and the predetermined depth threshold value is 100 μm.

After the implementation of a data processing step 23, a question Q1 is answered regarding the presence of a number of defects greater than a predetermined threshold value and/or the presence of at least one defect with dimensions greater than a predetermined threshold value, the threshold values being predetermined for a given part P. If the answer to Q1 is that there is number of defects greater than the predetermined threshold value and/or the presence of at least one defect with dimensions greater than the predetermined threshold value, NOK in the diagram in FIG. 2, then the method goes to step 24 of scrapping the unfinished part P. If not, OK in the diagram in FIG. 2, the part P is finished, by repeating steps 21 and 22.

At the end of the production of the part P, a question Q2, similar to question Q1, is asked. If the answer to Q2 is that there is number of defects greater than the predetermined threshold value and/or the presence of at least one defect with dimensions greater than the predetermined threshold value, NOK in the diagram in FIG. 2, then the method goes to step 24 of scrapping the unfinished part P. If not, OK in the diagram in FIG. 2, the finished part P is validated in a step 25.

The inspection performed during manufacturing according to this method is a form of non-destructive testing, also known as NDT, but which takes place throughout manufacturing, unlike the usual non-destructive testing, which is carried out on the finished part. This step of usual non-destructive testing on the finished part is thus unnecessary, due to the invention, which eliminates both the need for this usual final step and the need to invest in the NDT system used to implement it, which systems are generally costly.

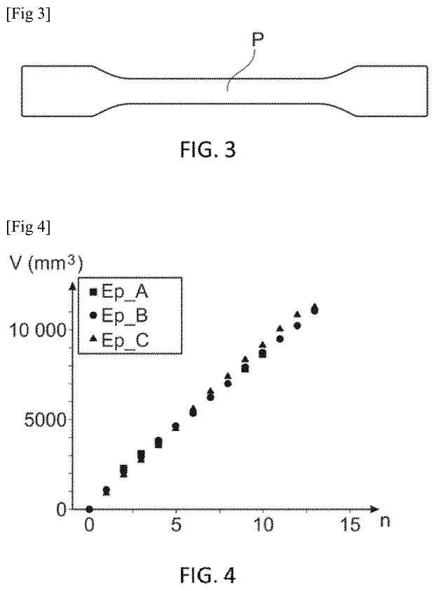

FIG. 3 shows a part P, consisting of a tensile test specimen, produced using the method described with reference to FIG. 2, implemented by the additive manufacturing machine 1.

Three parts P consisting of tensile test specimens respectively named Ep_A, Ep_B and Ep_C, were produced to the template of the part P illustrated in FIG. 3 using the machine 1 and the additive manufacturing method described above, with the same parameters and setpoint values.

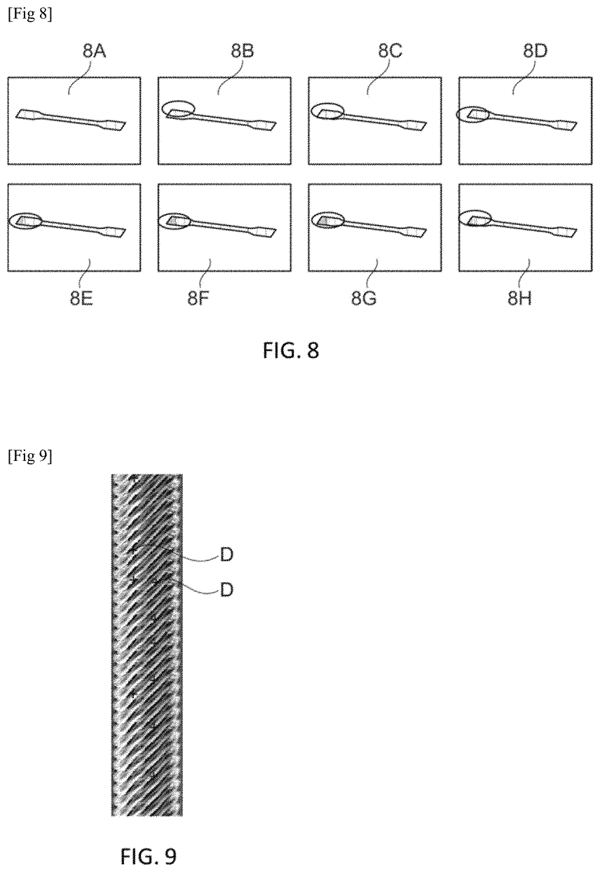

FIG. 8 illustrates several scanned layers C of test specimen Ep_C. The image entitled 8A illustrates the second layer deposited and scanned, the image entitled 8B shows the third layer, image 8C the fourth layer, image 8D the fifth layer, image 8E the sixth layer, image 8F the seventh layer, image 8G the twelfth layer and image 8H the thirteenth layer. In images 8B to 8H, a circled zone with at least one visible missing material defect can be seen.

FIGS. 4 to 7 illustrate graphs at least partially showing the results of the processing of data acquired about the part P during manufacturing, by scanning after the depositing of each layer C, for each of the test specimens Ep_A, Ep_B and Ep_C.

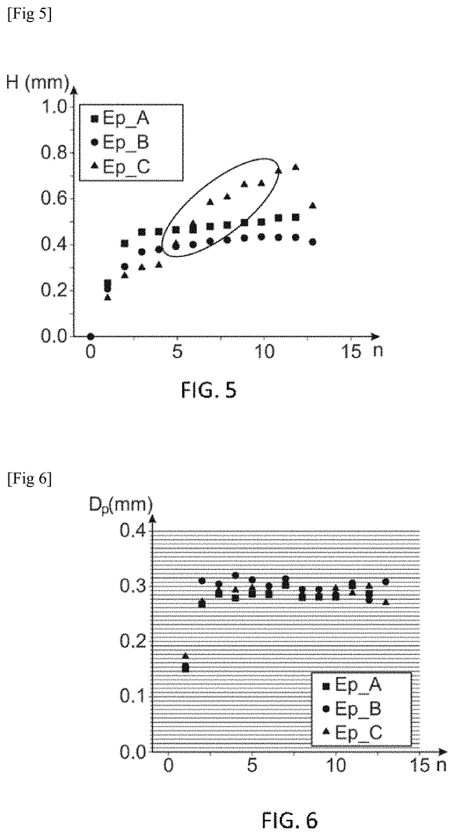

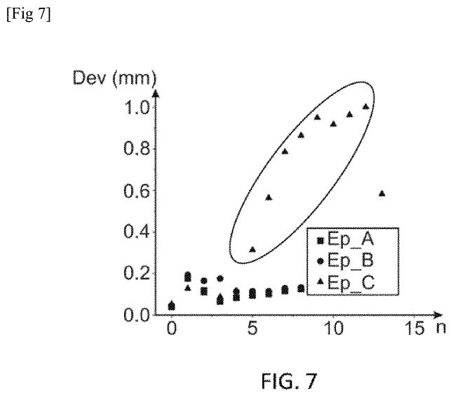

The graph in FIG. 4 shows the volume V expressed in mm³, as a function of the tier n of each layer C. The graph in FIG. 5 illustrates the mean height H per layer, expressed in mm, as a function of the tier n of each layer C. The graph in FIG. 6 illustrates the movement of the carriage, Dp, expressed in mm, as a function of the tier n of each layer C. The graph in FIG. 7 shows the standard deviation of the layer height, Dev, expressed in mm, as a function of the tier n of each layer C. The tier n corresponds to the number of the layer C deposited. The first layer deposited is tier 1, the second layer, deposited on the first layer, is tier 2, etc., up to the highest tier, which corresponds to the last layer deposited to produce the part P. On the graphs in FIGS. 4 to 7, the values illustrated for test specimen Ep_A are small squares, those for test specimen Ep_B are small circles, and those for test specimen Ep_C are small triangles.

In FIGS. 5 and 7, outliers can be seen for test specimen Ep_C, circled on the graphs, showing a layer height defect and a very significant standard deviation, which can also be seen in FIG. 8, as stated above.

FIG. 9 illustrates a portion of a part P to show the detection of missing material defects D, identified by small crosses in this figure. When missing material defects are located by scanning and processing of the scan data, they are compared with threshold values, for example with dimensions greater than 5 μm*5 μm and a depth greater than 10 μm. When a defect has a size greater than at least one of the threshold values, its coordinates, size (on the surface) and depth are recorded. This can make it possible to decide whether to retain and continue to manufacture the part P, or to scrap it.

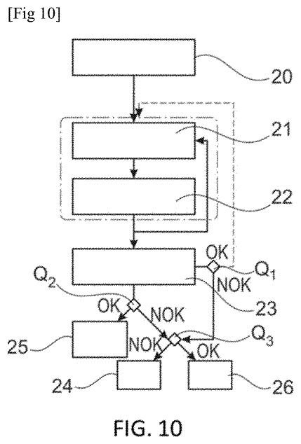

FIG. 10 shows an embodiment of the method for repairing a part during additive manufacturing according to the invention. In this example, the method can include the same steps as in those shown in the method illustrated in FIG. 2, but also includes a missing material defect repair step according to the invention, as will be explained below.

As illustrated in FIG. 10, when the answer to question Q1 or question Q2 is NOK, a question Q3 regarding the possibility of repairing the missing material defect(s) is asked. If the answer to this question Q3 is yes, OK in the diagram, the layer C affected by the defect and/or the part P is repaired by adding material in a step 26. Conversely, if the answer to this question Q3 is no, NOK in the diagram, the part, finished or otherwise, is scrapped.

It must be noted that the data acquired by scanning in the present invention can be placed into two categories, allowing two types of analysis. Firstly, the overall values per layer, mentioned above, can be acquired and analyzed, in particular compared with the reference values and setpoint values, in order to monitor the additive manufacturing method. Secondly, the missing material defects, in particular those that can be corrected, can be detected and geolocated in order to be processed and repaired by adding material.

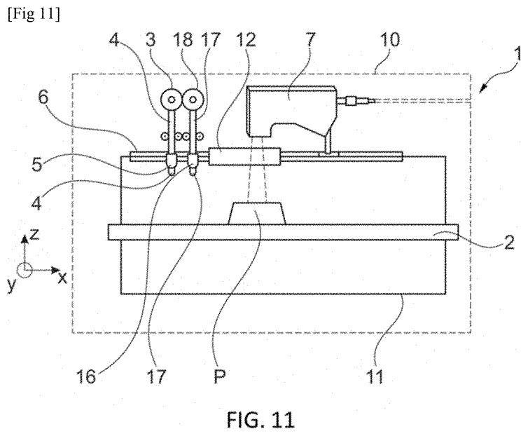

For the implementation of the method according to the invention illustrated in FIG. 10, the additive manufacturing machine 1 illustrated in FIG. 11 can be used, which includes a second nozzle 16 supplied with a second polymer material filament 17 by a second spool 18. In the example illustrated, the second filament 17 is produced using a more fluid polymer material than the filament 4. The second nozzle 16 has a smaller diameter than the nozzle 5. The second nozzle 16 and the filament 17 are used to repair the missing material defects.

For the implementation of the method according to the invention illustrated in FIG. 10, the additive manufacturing machine 1 illustrated in FIG. 2 can also be used, and the nozzle 5 and the filament 4 can then be used to repair the missing material defects.

If necessary, the missing material defect(s) can be repaired after the production of one layer, or several layers, or even during the production of a layer that is not fully deposited on the previous layer or on the support 2. When the repair is made after the production of a layer, another layer can then be deposited on top of it, then the scan can be performed, then the data can be processed and any further repairs made, and so on until the part is produced.

In addition, when one or more missing material defect(s) is/are repaired, a scan can be performed to check the repair. If it is satisfactory, the next layer can be deposited. If the repair is unsatisfactory, the defect(s) can be repaired again, before checking by scanning and/or depositing a new layer.

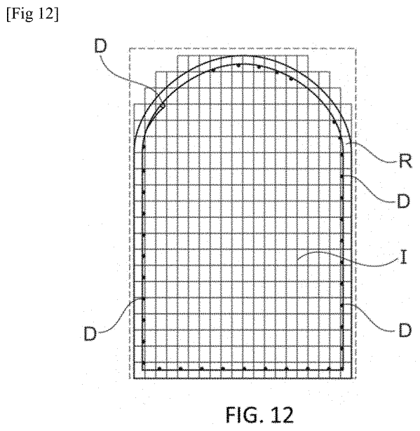

FIG. 12 schematically shows a layer of a part viewed after deposition, scanning and data processing. The outline R of the part is visible. The infill I of the layer that is inside the outline R can also be seen, and zones with missing material defects D can be detected between the outline R and the infill I, at the junction thereof. It must be noted that a certain overlap between the two zones R and I makes it possible to fill some of these defects, but, as can be seen in this figure, some missing material defects D remain and must be repaired using the invention. Only a certain amount of overlapping can be performed during the deposition of material, as it can cause damage to the surface.

One advantage of the invention is that it makes it possible to repair a zone with missing material defects during the manufacturing of the part. Another advantage is that the porosity in the overlap zones between the outline and the infill can be reduced. A further advantage is that of limiting the number of parts scrapped as they have too many missing material defects or one or more missing material defects that are too large.

The invention is not limited to the examples that have just been described.

In particular, the additive manufacturing method can be other than FDM technology.

In particular, the additive manufacturing method can consist of binder jetting 3D printing, which includes in particular drop-on-demand (DOD) technology, powder bed fusion 3D printing, which includes in particular selective laser sintering (SLS) and selective laser melting (SLM) technologies, material jetting 3D printing, directed energy deposition 3D printing, or vat photopolymerization 3D printing, which includes in particular stereolithography (SLA) technology. The method can also be a mixture of these different technologies such as multi jet fusion (MJF) technology, which combines binder jetting and power bed fusion.

1. A method for repairing a part during layer-by-layer additive manufacturing using an additive manufacturing machine, the additive manufacturing being material extrusion printing, the method including:
a) depositing at least one layer of material on a support for manufacturing the part,
b) detecting at least one missing material defect, if one or more defects of this type are present on said at least one layer,
c) repairing said at least one missing material defect by adding material,
d) repeating steps a), b) and optionally c) until the part (P) is produced.

2. The method as claimed in claim 1, in which step a) of depositing said at least one layer of material is performed using a nozzle fastened to a carriage, said carriage being movable along at least two axes relative to the support.

3. The method as claimed in claim 1, in which the material added in step c) is different from the material deposited for each layer in step a), preferably being more fluid.

4. The method as claimed in claim 2, in which step c) of repairing said at least one missing material defect is carried out by the nozzle.

5. The method as claimed in claim 2, in which step c) of repairing said at least one missing material defect is carried out by a second nozzle.

6. The method as claimed in claim 5, in which the second nozzle has a smaller diameter than the nozzle.

7. The method as claimed in claim 1, in which step b) of detecting at least one missing material defect includes a scanning said at least one layer, deposited in step a), in order to acquire topographical data about said at least one layer, and a processing of the data acquired in order to detect and geolocate at least one missing material defect, if one or more defects of this type are present on said at least one layer.

8. The method as claimed in claim 7, the scanning being implemented using a scanning tool selected from the group consisting of a profilometer, laser profilometer, a distance sensor, a camera, a mechanical profilometer or a 3D scanner, capable of scanning the part.

9. The method as claimed in claim 1, in which the material used for additive manufacturing and/or the material added in the repair step c) is a thermoplastic polymer selected from the group consisting of PAEKs (polyaryletherketone), including PEEK (polyetheretherketone) and PEKK (polyetherketoneketone), PEIs (polyetherimide, also known as ULTEM), PPS (polyphenylene sulfide), ABS (acrylonitrile butadiene styrene), PA (polyamide), PP (polypropylene), PLA (polylactic acid), TPU (thermoplastic polyurethane) and PET (polyethylene).

10. The method as claimed in claim 1, in which step a) is carried out by depositing extruded polymer filament.

11. An additive manufacturing machine for implementing the method as claimed in claim 1, the additive manufacturing being material extrusion printing, the machine including:
a support for the part to be manufactured,
at least one spool of polymer material filament,
at least one nozzle for extruding and depositing the filament in order to form the part,
a carriage to which the nozzle,
at least one of the carriage and the support being movable along at least two axes relative to the other,
said at least one nozzle being used for repairing missing material defects or the machine including a second nozzle for repairing missing material defects, the second nozzle being fastened to the carriage.

12. The machine as claimed in claim 11, including a scanning tool selected from the group consisting of a profilometer, an optical, camera or laser profilometer, a distance sensor, a camera, a mechanical profilometer and a 3D scanner, capable of scanning the part.

13. The method as claimed in claim 2, in which said carriage being movable along three orthogonal axes relative to the support.
